(19) United States
(12) Patent Application Publication
(10) Pub. No.: US 2014/0149934 A1
(43) Pub. Date: May 29, 2014

(54) Method, Apparatus and Computer Program Product for Managing Content

(71) Applicant: Sudha Bheemanna, Bangalore (IN)

(72) Inventor: Sudha Bheemanna, Bangalore (IN)

(21) Appl. No.: 14/127,701

(22) PCT Filed: Jun. 6, 2012
(86) PCT No.: PCT/FI2012/050563

§ 371 Date: Feb. 10, 2014

(30) Foreign Application Priority Data
Jun. 30, 2011 (IN) 2241/CHE/2011

(51) Int. Cl. G06F 3/0488; G06F 3/0482

(52) U.S. Cl. CPC G06F 3/0488; G06F 3/0482
USPC 715/810

(57) ABSTRACT

In accordance with an example embodiment a method and apparatus is provided. The method comprises facilitating receiving of at least one gesture for at least one content item, and inhibiting accessibility of the at least one content item based on the at least one gesture. The apparatus comprises at least one processor; and at least one memory comprising computer program code, the at least one memory and the computer program code configured to, with the at least one processor, cause the apparatus at least to perform: facilitating receiving of at least one gesture for at least one content item; and inhibiting accessibility of remaining content items for which the at least one gesture is not received.

### TECHNICAL FIELD

Various implementations relate generally to method, apparatus, and computer program product for managing content.

### BACKGROUND

The rapid advancement in technology related to capture and display of content has resulted in an exponential growth in tools related to content creation. Devices like mobile phones and personal digital assistants (PDA) are now being increasingly configured with media capture tools, such as a camera, thereby facilitating easy capture of content.

The content available at the device may be provided as an output by using various output means for example, a display, speaker, and the like. It is common to have individuals share/manage content displayed on their devices with colleagues, family and/or friends. In an example, an individual may wish to selectively share some content.

### SUMMARY OF SOME EXAMPLE EMBODIMENTS

Various aspects of examples embodiments are set out in the claims.

In a first aspect, there is provided a method comprising: facilitating receiving of at least one gesture for at least one content item; and inhibiting accessibility of the at least one content item based on the at least one gesture.

In a second aspect, there is provided a method comprising: facilitating receiving of at least one gesture for at least one content item; and inhibiting accessibility of remaining content items for which the at least one gesture is not received.

In a third aspect, there is provided an apparatus comprising: at least one processor; and at least one memory comprising computer program code, the at least one memory and the computer program code configured to, with the at least one processor, cause the apparatus at least to perform: facilitating receiving of at least one gesture for at least one content item; and inhibiting accessibility of the at least one content item based on the at least one gesture.

In a fourth aspect, there is provided an apparatus comprising: at least one processor; and at least one memory comprising computer program code, the at least one memory and the computer program code configured to, with the at least one processor, cause the apparatus at least to perform: facilitating receiving of at least one gesture for at least one content item; and inhibiting accessibility of remaining content items for which the at least one gesture is not received.

In a fifth aspect, there is provided a computer program product comprising at least one computer-readable storage medium, the computer-readable storage medium comprising a set of instructions, which, when executed by one or more processors, cause an apparatus to at least perform: facilitating receiving of at least one gesture for at least one content item; and inhibiting accessibility of the at least one content item based on the at least one gesture.

In a sixth aspect, there is provided a computer program product comprising at least one computer-readable storage medium, the computer-readable storage medium comprising a set of instructions, which, when executed by one or more processors, cause an apparatus to at least perform: facilitating receiving of at least one gesture for at least one content item; and inhibiting accessibility of remaining content items for which the at least one gesture is not received.

In a seventh aspect, there is provided an apparatus comprising: means for facilitating receiving of at least one gesture for at least one content item; and means for inhibiting accessibility of the at least one content item based on the at least one gesture.

In an eighth aspect, there is provided a computer program comprising program instructions which when executed by an apparatus, cause the apparatus to: facilitate receiving of at least one gesture for at least one content item; and inhibit accessibility of the at least one content item based on the at least one gesture.

In ninth aspect, there is provided an apparatus comprising:means for facilitating receiving of at least one gesture for at least one content item; and means for inhibiting accessibility of remaining content items for which the at least one gesture is not received.

In tenth aspect, there is provided a computer program comprising program instructions which when executed by an apparatus, cause the apparatus to: facilitate receiving of at least one gesture for at least one content item; and inhibit accessibility of remaining content items for which the at least one gesture is not received.

### BRIEF DESCRIPTION OF THE FIGURES

The embodiments of the invention are illustrated by way of example, and not by way of limitation, in the figures of the accompanying drawings in which:

FIG. 1 illustrates a device in accordance with an example embodiment;

FIG. 2 illustrates an apparatus for managing content in accordance with an example embodiment;

FIG. 3A illustrates a display for facilitating receiving of gestures for at least one content item in accordance with an example embodiment;

FIG. 3B illustrates a display for inhibiting accessibility of the content items based on the gestures in accordance with an example embodiment;

FIG. 3C illustrates a display for inhibiting accessibility of the content items based on the gestures in accordance with another example embodiment;

FIG. 3D illustrates a display for inhibiting accessibility of the at least one content item based on the gesture in accordance with another example embodiment;

FIG. 3E illustrates a display for facilitating selection of content items in accordance with another example embodiment;

FIG. 4 is a flowchart depicting an example method for managing content in accordance with an example embodiment; and

FIG. 5 is a flowchart depicting an example method for managing content in accordance with another example embodiment.

### DETAILED DESCRIPTION

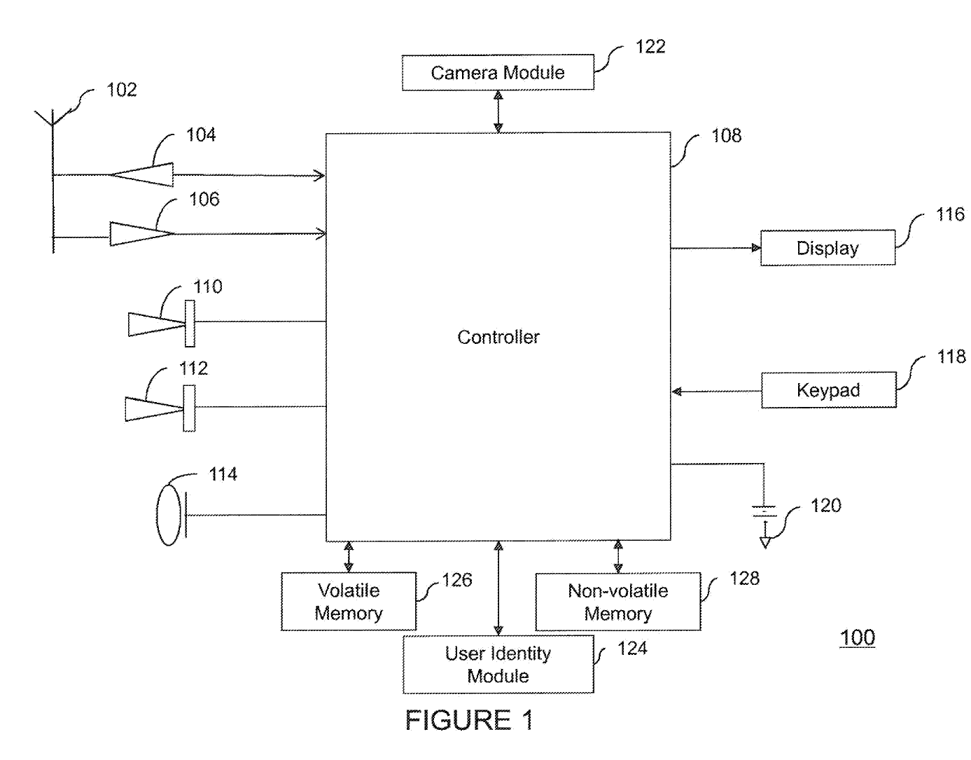

Example embodiments and their potential effects are understood by referring to FIGS. 1 through 5 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of electronic devices, mobile communication devices, media devices or any combination of the aforementioned, and other types of communications devices. Examples of electronic devices may include all types of computers (for example, laptops, mobile computers, desktops or tablets), cameras, non-portable displays, such as non-portable televisions, digital photo frames, gaming devices and the like. Examples of mobile communication devices may include cellular phones, smart phones, portable digital assistants (PDAs), pagers and the like. Examples of media devices may include multimedia devices like media players, mobile digital assistants and the like.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access), GSM (global system for mobile communication), and IS-95 (code division multiple access), or with third-generation (3G) wireless communication protocols, such as Universal Mobile Telecommunications System, CDMA1000, wideband CDMA (WCDMA) and time division-synchronous CDMA, with 3.9G wireless communication protocol such as evolved-universal terrestrial radio access network, with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network.

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays, one or more controllers, one or more application-specific integrated circuits, one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol, Hypertext Transfer Protocol and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capture element, such as a camera, video and/or audio module, in communication with the controller 108. The media capture element may be any means for capturing an image, video and/or audio for storage, display or transmission. In an example embodiment in which the media capture element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the other side of the device 100 with respect to the display 116. Alternatively, the display 116 may be located on one side of the device 100 and the camera module 122 may include a lens positioned on both sides of the device 100 with respect to the display 116 to enable the camera module 122 to capture images on both sides of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

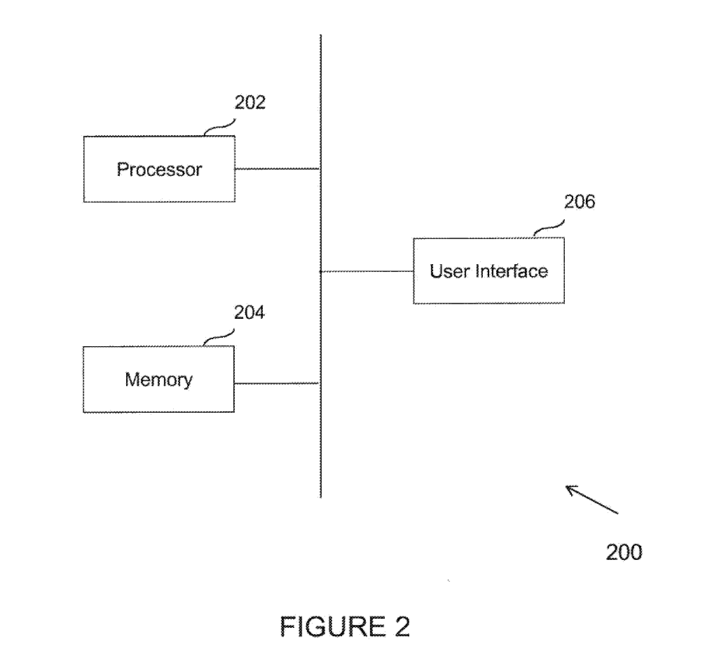

FIG. 2 illustrates an apparatus 200 for managing content in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus is a multimedia device. In another example embodiment, the apparatus 200 is a mobile phone, which may be an example of a multimedia device with communication capabilities. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory include, but are not limited to, random access memory, dynamic random access memory, static random access memory, and the like. Some example of the non-volatile memory include, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions and the like for enabling the apparatus 200 to carry out various functions in accordance with various example embodiments. For example, the memory 204 may be configured to buffer input data comprising content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit, a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor display, liquid crystal displays, active-matrix organic light-emitting diode display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the processor 202 is configured to, with the content of the memory 204, and optionally with other components described herein, to cause the apparatus 200 to enable a user to manage or share content. Some examples of the content items may include multimedia files, audio files, video files, text files, icons, hyperlinks, bookmarks, and thumbnails and/or the like. Examples of image files may include still pictures, for example, photos captured using an image sensor or pictures received from an external device and stored locally in the memory 204. Examples of the video files may include may include motion pictures, for example, videos captured using the image sensor, or videos received from the external device and stored locally in the memory 204. The image sensor and other circuitries, in combination, may be an example of the camera module 122 of the device 100. The image sensor may be in communication with other imaging circuitries and/or software, and may be configured to capture digital images or to make a video or other graphic media files. Examples of the audio files may include may include sound recordings, voice notes, or audios received from the external device and stored locally in the memory 204. Examples of the thumbnails may include reduced-size version of the image files providing an inline image link to the larger image files. Examples of icons may include graphical representations, small pictures or symbols serving as hyperlink or a shortcut for accessing associated image files, audio files and/or video files. Examples of links may include reference or pointers to other content items, such as image files, audio files, video files, and thumbnails.

The memory 204 of the apparatus 200 may be configured to store a plurality of content items. The content items may be displayed to a user on a display of the user interface 206 for accessing the content items from the memory 204 for viewing purposes. In some example embodiments, the apparatus 200 may also receive the content items from another memory of the apparatus 200 and/or from some external memory, and the apparatus 200 may be configured to display the received content items. The user may want other users to view some of the content items. The user may wish to reserve remaining content files for personal viewing purposes.

In an example embodiment, the processor 202 is configured to, with the content of the memory 204, and optionally with other components described herein, to cause the apparatus 200 to facilitate receiving of at least one gesture for at least one content item. In an example embodiment, the gestures may be received from the user for content items that the user wants to inhibit the access to. In an alternate embodiment, the gestures may be provided for content items that the user wants the other users to view. Examples of gestures may include touch-screen gestures, such as by drawing any of a tick sign, a cross sign, an asterisk mark, a star sign, a mathematical symbol or a user-defined symbol on the content items. In an alternate embodiment, the user may choose to provide the gestures by input means non-exhaustively including a touch-screen, a joystick, a trackball, and a keypad. In an example embodiment, the gestures may be pre-stored in the memory 204 or in some internal or external memory. In an alternate embodiment, a user may define one or more gestures and store the gesture(s) in the memory 204 or in some internal or external memory. In an example embodiment, a processing means may be configured to facilitate receiving of the at least one gesture for the content items. An example of the processing means may include the processor 202, which may be an example of the controller 108.

In an example embodiment, the processor 202 is configured to, with the content of the memory 204, and optionally with other components described herein, to cause the apparatus 200 to inhibit accessibility of the at least one content item based on the gesture. In an example embodiment, access to the content items for which gestures have been provided may be inhibited. In an example embodiment, inhibiting the accessibility of the content items comprises replacing the content items with at least one dummy content item. Examples of dummy content items may include images, mock-up drawings, cartoon signage, or symbols pre-stored in the memory 204 or in some internal or external memory. In an alternate embodiment, a user may define one or more dummy content items and store the dummy content items in the memory 204 or in some internal or external memory. The dummy content items may replace the content items for which gestures have been provided to inhibit access to the content item. A modified display with the dummy content items may be provided for accessing remaining content items for which gestures have not been received.

In another example embodiment, inhibiting accessibility to the content items comprises blurring the content items. A modified display with the blurred content items may be provided for accessing remaining content items for which gestures have not been received. In an alternate example embodiment, inhibiting accessibility to the content items comprises hiding the content items. A modified display with the hidden content items may be provided for accessing remaining content items for which gestures have not been received.

In an example embodiment, the processor 202 is configured to, with the content of the memory 204, and optionally with other components described herein, to cause the apparatus 200 to receive a selection of a gesture mode for facilitating receipt of gestures for the content items. In an example embodiment, the gesture mode is a display mode enabling a user to configure display of the user interface 206. On providing the selection of the gesture mode, a display of plurality of content items may be provided to the user. The user may then provide one or more gestures for some of the content items for inhibiting access to these content items. In an example embodiment, the apparatus 200 may be configured to treat the received gestures as passwords for inhibiting access to the content items. Access to the content items may be inhibited by the gestures, which may be further utilized for regaining access to the content items. In an example embodiment, a gesture that is utilized for inhibiting access to a particular content item may be utilized for re-accessing the content item. However, in some example embodiments, a particular gesture may be reserved for re-accessing the content items.

In an example embodiment, a user may provide different gestures for different content items.

For example, a user may provide a cross sign gesture, a question-mark gesture and a dot sign gesture for different content items. A display of the content items may be modified and an access to the content items for which these gestures are received may be inhibited in the display.

In an example embodiment, the processor 202 is configured to, with the content of the memory 204, and optionally with other components described herein, to cause the apparatus 200 to facilitate receipt of the at least one gesture for the at least one inhibited content item. For example, if the user wishes to facilitate access to the inhibited content items, the user may provide a selection of the gesture mode. On selection of the gesture mode, the user may provide gestures utilized for inhibiting access to the content items. For example, the cross sign gesture may be provided by the user to facilitate access to the content items for which access was inhibited based on the cross sign gesture. Similarly, the user may provide the question-mark gesture and the dot sign gesture to facilitate access to the content items for which access was inhibited based on the respective gestures. In an example embodiment, a user may provide different gesture for each different type of the content items. For example, the user may provide a ‘minus’ (mathematical symbol) gesture for inhibiting access to some of the image files and a “equal to” (mathematical symbol) gesture for inhibiting access to some of the audio/video files. A display may be modified based on the received gestures. The apparatus 200 may be caused to provide the modified display for viewing purposes of the remaining content files. An access to the inhibited image files may be facilitated by providing the ‘minus’ gesture and an access to the inhibited audio/video files may be facilitated by providing the ‘equal to’ gesture. In another example embodiment, a single gesture may be provided for inhibiting access to one or more content items. In an example embodiment, a processing means may be configured to facilitate receiving the gesture for the inhibited content item and facilitate access to the inhibited content item based on the received gesture. An example of the processing means may include the processor 202, which may be an example of the controller 108.

In an example embodiment, the processor 202 is configured to, with the content of the memory 204, and optionally with other components described herein, to cause the apparatus 200 to facilitate selection of the at least one content item. For example, if the user wants to inhibit access to ‘five’ content items, the user may provide a selection of the five content items by selecting the five content items using any of touch-screen gesture, joystick selection, keypad input and the like, and then provide a gesture for inhibiting access to the five content items. In an example embodiment, a ‘selection box’ may be provided adjacent to each content item in the gesture mode. In an example embodiment, on receiving a selection input for a content item, a sign such as a ‘tick sign’ may appear for the selected content item. On the selection of the content items, a pre-defined gesture (either user-defined gesture or in-built gesture stored in the memory 204) may be provided to inhibit access to the selected content items. In an example embodiment, a selection box may be provided at a convenient position of the screen of the display for receiving the gesture for the selected content items. For example, the user may provide the gesture on a substantially middle portion of the screen of the display for inhibiting access to the content items. In an example embodiment, access of the inhibited content items may be facilitated by providing the same gesture utilized for inhibiting access to the content items. In an example embodiment, the user may provide different gestures in the selection boxes associated with content items for inhibiting access and subsequent selective retrieval of the content items.

In an example embodiment, the gestures may be provided for content items that the user wants the other users to view. An access to the content items may be inhibited for the remaining content items for which the gesture is not received. For example, if the user wants other user to view or wants to share ‘four’ content items out of ten displayed content items, gestures may be received from the user for the four content items and an access to the remaining six content items may be inhibited. In an example embodiment, the remaining content items may be replaced by dummy content items. In another example embodiment, the remaining content items may be blurred for inhibiting access to the content items. In yet another example embodiment, the remaining content items may be hidden for inhibiting access to the content items. A display may be modified to reflect the inhibited access to the content items. The modified display may be provided for accessing the content items for which access is facilitated. In an example embodiment, a processing means may be configured to facilitate receiving of at least one gesture for at least one content item and inhibit accessibility of remaining content items for which gesture is not received. An example of the processing means may include the processor 202, which may be an example of the controller 108.

In an example embodiment, the apparatus 200 may include a content device. Some examples of the content device include a computing device, a communication device, a media playing device and the like. Some examples of computing device may include a laptop, a personal computer, and the like. Some examples of the communication device may include a mobile phone, a personal digital assistant (PDA), and the like. Some examples of the media playing device may include audio/video players, cameras and the like. The communication device may comprise a user interface circuitry and user interface software configured to facilitate a user to control at least one function of the communication device through use of a display and further configured to respond to user inputs. The user interface circuitry may be similar to the user interface explained in FIG. 1 and the description is not included herein for sake of brevity of description. Additionally or alternatively, the communication device may include a display circuitry configured to display at least a portion of a user interface of the communication device, the display and display circuitry configured to facilitate the user to control at least one function of the communication device. Additionally or alternatively, the communication device may include typical components such as a transceiver (such as transmitter 104 and a receiver 106), volatile and non-volatile memory (such as volatile memory 126 and non-volatile memory 128), and the like. The various components of the communication device are not included herein for the sake of brevity of description.

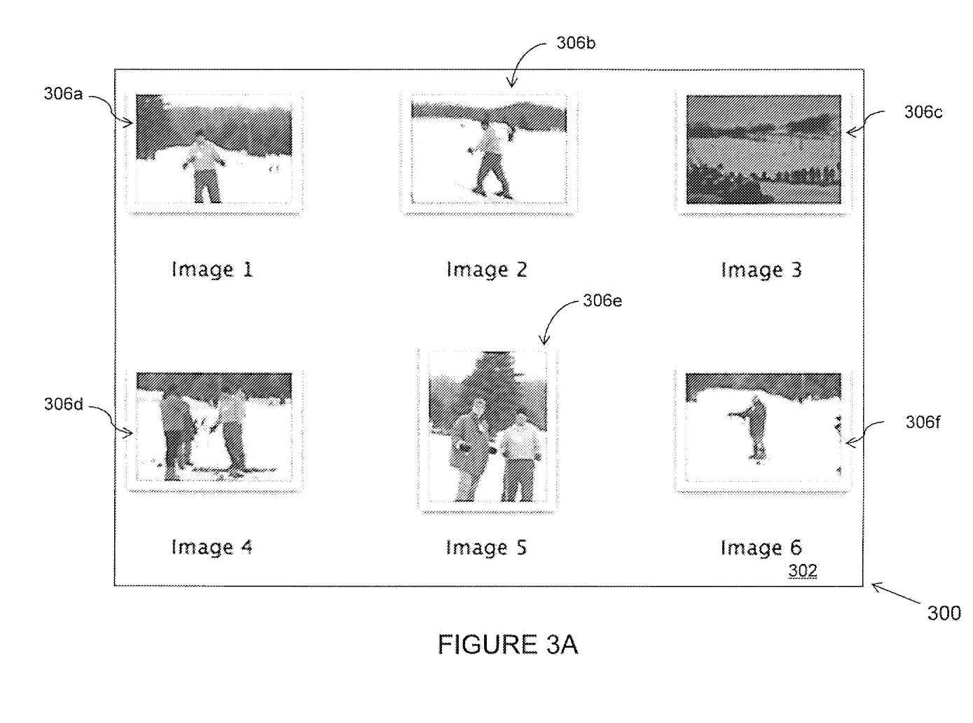

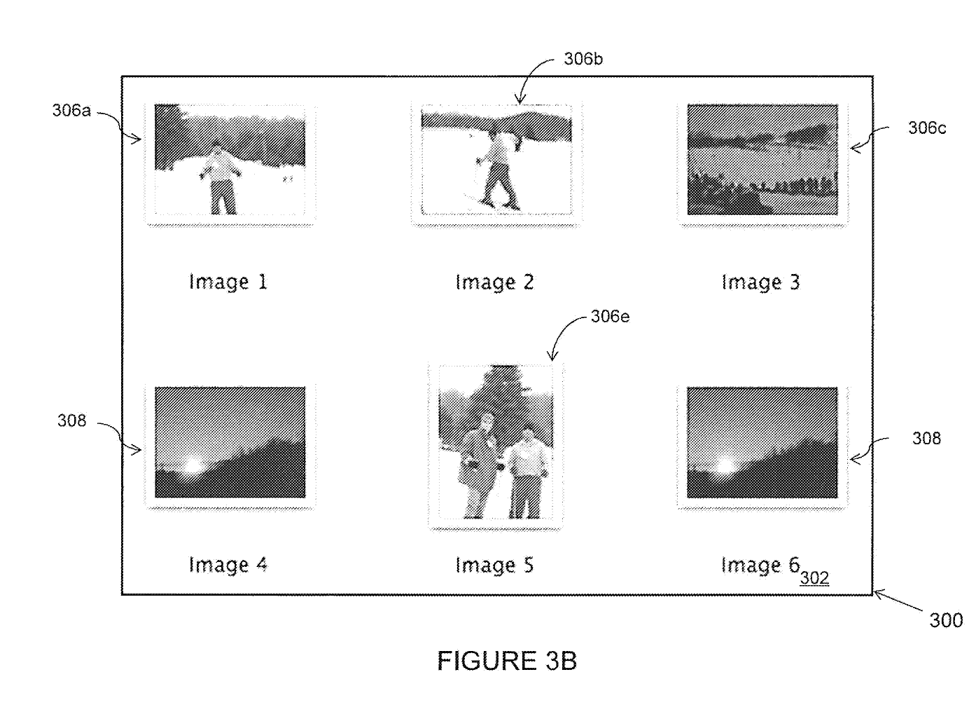

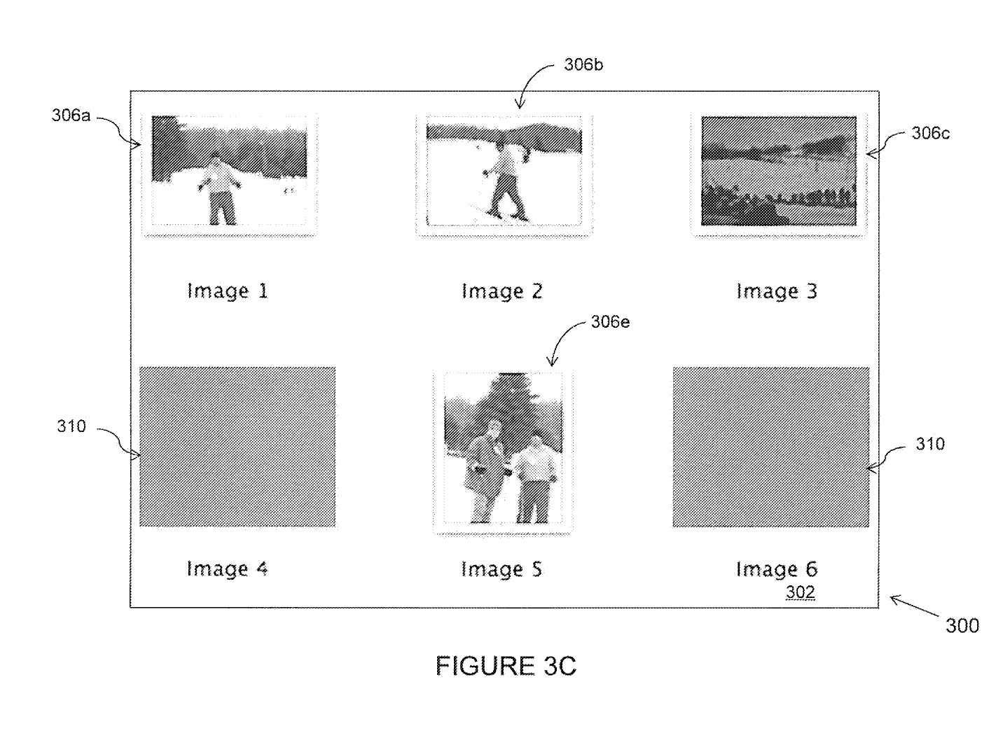

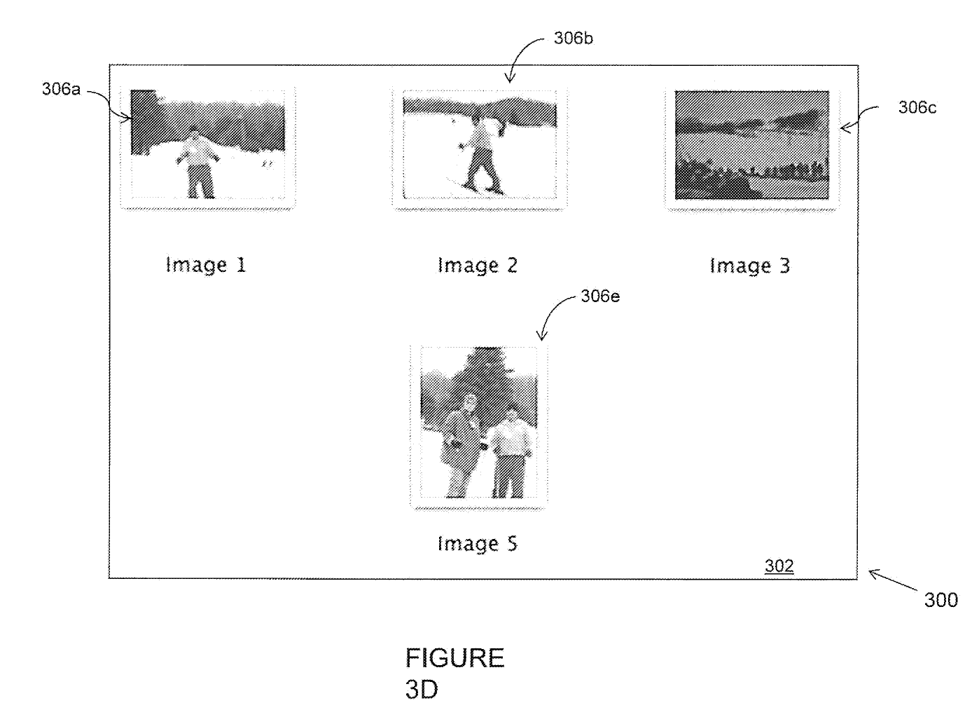

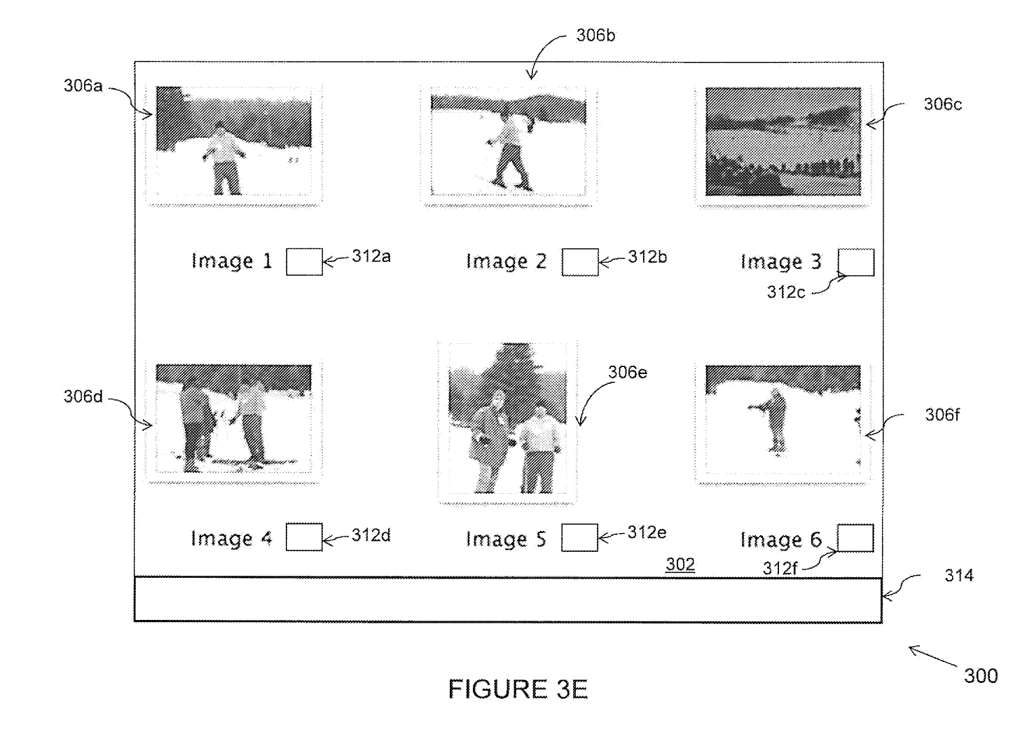

FIG. 3A illustrates a display 300 for facilitating receiving of gestures for at least one content item in accordance with an example embodiment. The display 300 may be an example of the display 116 of the device 100 or the user interface 206 of the apparatus 200. A plurality of content items, such as thumbnail 306a, thumbnail 306b, thumbnail 306c, thumbnail 306d, thumbnail 306e and thumbnail 306f are displayed on screen 302 of the display 300. In an embodiment, thumbnails 306a-306f are associated with a corresponding textual representation Image 1-Image 6 denoting a link to a larger image file. In another embodiment, the thumbnails 306a-306f can be hypermedia used for accessing corresponding larger image. The thumbnails corresponding to image files are depicted as an example of content items displayed on the screen 302 of the display 300. The display 300 may be configured to depict other content items, such as audio files, video files, icons of audio and/or video files, links, image files and the like. In an example embodiment, a user of the apparatus 200 may want the other users to view some of the image files associated with the plurality of thumbnails displayed on display 300. In an example embodiment, the user may provide a selection of a gesture mode and receive the display 300 with the displayed plurality of content items as shown in FIG. 3A. In an embodiment, the display 300 facilitates receiving of gestures for the displayed content items.

In an example embodiment, the gestures may be received for content items that the user wants to inhibit the other users from viewing. In an alternate embodiment, the gestures may be provided for content items that the user wants the other users to view. Examples of gestures may include touch-screen gestures, such as drawing a tick sign, a cross sign, an asterisk mark, a star sign, a mathematical symbol, a user-defined symbols or gestures, alphabets, combination thereof, and the like on the display area displaying the content items. In an alternate embodiment, the user may choose to provide the gestures by input means non-exhaustively including a touch-screen input, a joystick input, a mouse pointer, or a keypad selection.

In an example embodiment, access to the content items for which gestures have been received may be inhibited. For example, if the user wishes to inhibit access to image 4 and image 6 (thumbnails 306d and 306f, respectively), then the user may provide gesture for the content items, image 4 and image 6. Some examples techniques of inhibiting access to the images 4 and 6 for which gestures have been received is explained in FIGS. 3B-3E.

FIG. 3B illustrates a display 300 for inhibiting accessibility of the content items based on the gestures in accordance with an example embodiment. The user may wish to inhibit access to image 4 and image 6 shown in FIG. 3A, and, may provide gesture for the content items depicted by image 4 and image 6. The display 300 of FIG. 3B depicts a screen 302 with dummy content item 308 replacing the original images 4 and 6 displayed in FIG. 3A for inhibiting access to the content items for which gesture is received. In FIG. 3B, the dummy content item 308 is depicted to be an image thumbnail of a landscape scenery, however, any proxy image, mock-up drawing, cartoon or mathematical symbols, may be utilized as dummy content item for replacing the content items for which gestures are received. The dummy content items may be pre-stored in the memory 204 or in some internal or external memory. In an alternate embodiment, a user may define one or more dummy content items and store the content items in the memory 204 or in some internal or external memory. The dummy content items may replace the content items for which gestures have been provided to inhibit access to the content item. In another form, a modified display with the dummy content items may be provided for accessing remaining content items for which gestures have not been received. In an alternate embodiment, the gesture may be provided for content items that the user wants the other users to view/experience. In this form, the dummy content items may replace the remaining content items, such as thumbnails 306a, 306b, 306c and 306e.

FIG. 3C illustrates a display 300 for inhibiting accessibility of the content items based on the gestures in accordance with another example embodiment. The user may wish to inhibit access to image 4 and image 6 shown in FIG. 3A, and, may provide gesture for the content items depicted by image 4 and image 6. The display 300 of FIG. 3C depicts a screen 302 with the images 4 and 6 blurred (depicted blurred images 310) for inhibiting access to the content items for which gesture is received (for example, the images 4 and 6). The blurring of content items (for example, the images 4 and 6) may serve to inhibit access to the images 4 and 6. In this embodiment, remaining content items (for example, images 1, 2, 3 and 5) may be accessed for which gestures have not been received. In an alternate embodiment, the gesture may be provided for content items that the user wants the other users to view. In this form, the remaining content items, such as thumbnails 306a, 306b, 306c and 306e may be blurred while retaining the thumbnails 306d and 306f in original form.

FIG. 3D illustrates a display 300 for inhibiting accessibility of the content items based on the gestures in accordance with another example embodiment. The user may wish to inhibit access to the image 4 and the image 6 shown in FIG. 3A, and, may provide gesture for the content items depicted by the image 4 and the image 6. The display 300 of FIG. 3C depicts a screen 302 with the images 4 and 6 hidden for inhibiting access to the content items for which gesture is received. The hiding of content items (for example, the images 4 and 6) may serve to inhibit access to the images 4 and 6. In this embodiment, remaining content items (for example, images 1, 2, 3 and 5) may be accessed for which gestures have not been received. A modified display depicted in FIG. 3D shows blank spaces in place of the images 4 and 6, however, various arrangements of the remaining content items may be implemented. For example, the hidden content items may be sorted such that the blank spaces may be shifted to the end of the displayed content items for maintaining a continuity of image display. In an alternate embodiment, the gesture may be provided for content items that the user wants the other users to view. In this form, the remaining content items, such as thumbnails 306a, 306b, 306c and 306e may be hidden while retaining the thumbnails 306d and 306f in original form.

As explained in FIG. 2, the user may provide different gestures for different content items. The display 300 of the apparatus 200 may be configured to receive the different gestures as passwords for the different content items and inhibit access to the content items based on the received gestures as shown in FIGS. 3B-3D. The display may be configured to facilitate receiving the gestures for facilitating access to the inhibited content items. The display 300 may also be configured to receive selection of a plurality of content items as explained in FIG. 3E.

FIG. 3E illustrates a display 300 for facilitating selection of content items in accordance with an example embodiment. A plurality of content items, such as the thumbnails 306a-306f is displayed on screen 302 of the display 300. Each thumbnail 306a-306f is associated with a selection box. For example, thumbnail 306a is associated with selection box 312a. The thumbnails 306b-306f are similarly associated with selection boxes 312b-312f. A user may provide a touch-screen input to one or more thumbnails for selecting the thumbnails. A symbol or a sign may be displayed in the selection box to indicate the selection of the thumbnail. For example a ‘dot sign’ or a ‘check sign’ may appear in the selection box to indicate the selection of the thumbnail. On selection of the one or more content items (thumbnails), the user may provide a gesture in a gesture box 314 provided at the bottom of the screen 302 for associating the gesture to the plurality of selected thumbnails. An access to the selected thumbnails may be inhibited based on the gesture associated with the selected thumbnails. The inhibition of access to the content items may be performed as explained in example embodiments in FIGS. 3D to 3E.

A position of the gesture box 314 at the bottom of the screen 302 is depicted as an example, and, the gesture box 314 may be provided at any suitable location in the screen 302. In an example embodiment, the gesture box 314 may be a pop-up, which may be triggered on selection of one or more content items. In an alternate embodiment, the screen 302 may be configured to receive the gesture as a touch screen input without providing any gesture box 314. A user may provide the gesture on the screen 302 on selection of the content items to inhibit access to the selected content items. In an example embodiment, the user may assign different gestures to different collections of thumbnails by selecting thumbnail collections separately and assigning the gesture in the gesture box 314.

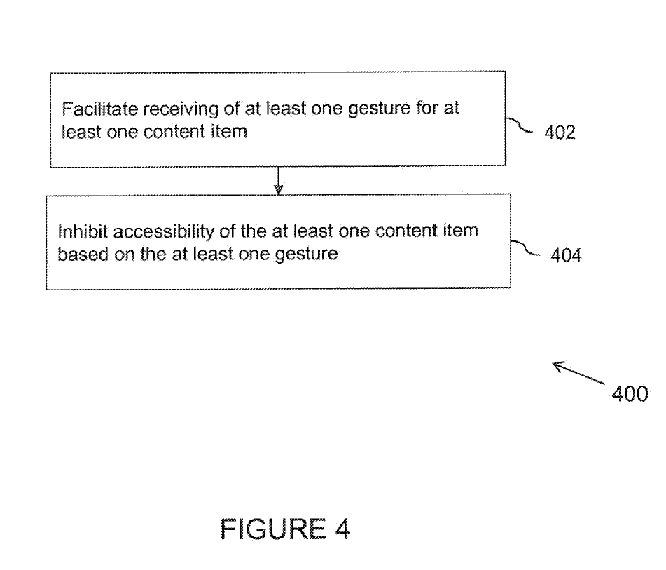

FIG. 4 is a flowchart depicting an example method 400 for managing content in accordance with another example embodiment. The method 400 depicted in flow chart may be executed by, for example, the apparatus 200 of FIG. 2.

Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus, provide operations for implementing the operations in the flowchart. The operations of the method 400 are described with help of apparatus 200. However, the operations of the method 400 can be described and/or practiced by using any other apparatus. In an example embodiment, the apparatus is a content device.

Examples of the content device could be any of a number of types of electronic devices, mobile communication devices, media devices or any combination of the aforementioned devices. Examples of electronic devices may include all types of computers (for example, laptops, mobile computers, desktops or tablets), cameras, non-portable displays, such as non-portable televisions, digital photo frames, gaming devices and the like. Examples of mobile communication devices may include cellular phones, smart phones, portable digital assistants (PDAs), pagers and the like. Examples of media devices may include media players, mobile digital assistants and the like.

At block 402, a receiving of at least one gesture for at least one content item is facilitated. Examples of content items may include image files, video files, audio files, thumbnails, icons, links and the like. Examples of image files may include still pictures, for example, photos captured using an image sensor or pictures received from an external device and stored locally in memory, such as the memory 204. Examples of the video files may include may include motion pictures, for example, videos captured using the image sensor, or videos received from the external device and stored locally in the memory. The image sensor and other circuitries, in combination, may be an example of the camera module 122 of the device 100. The image sensor may be in communication with other imaging circuitries and/or software, and may be configured to capture digital images or to make a video or other graphic media files. Examples of the audio files may include may include sound recordings, voice notes, or audios received from the external device and stored locally in the memory. Examples of the thumbnails may include reduced-size version of the image files providing an inline image link to the larger image files. Examples of icons may include graphical representations, small pictures or symbols serving as hyperlink or a shortcut for accessing associated image files, audio files and/or video files. Examples of links may include reference or pointers to other content items, such as image files, audio files, video files, and thumbnails.

In an example embodiment, the gestures may be provided for content items that the user wants to inhibit the access to. In an alternate embodiment, the gestures may be provided for content items that the user wants the other users to view. Examples of gestures may include touch-screen gestures, such as by drawing any of a tick sign, a cross sign, an asterisk mark, a star sign, a mathematical symbol or a user-defined symbol on the content items. In an alternate embodiment, the user may choose to provide the gestures by input means non-exhaustively including a touch-screen, a joystick, a trackball or a keypad. In an example embodiment, the gestures may be pre-stored in the memory. In an alternate embodiment, a user may define one or more gestures and store the gesture(s) in the memory.

At block 404, an access to the content items is inhibited based on the gesture. In an example embodiment, access to the content items for which gestures have been provided may be inhibited. In an example embodiment, inhibiting accessibility comprises replacing the at least one content item with at least one dummy content item. Examples of dummy content items may include images, mock-up drawings, cartoon signage, or symbols pre-stored in the memory. In an alternate embodiment, a user may define one or more dummy content items in the memory. The dummy content items may replace the content items for which gestures have been provided to inhibit access to the content item. A modified display with the dummy content items may be provided for accessing remaining content items for which gestures have not been received.

In another example embodiment, inhibiting accessibility to the content items comprises blurring of the content items. A modified display with the blurred content items may be provided for accessing remaining content items for which gestures have not been received. In an alternate example embodiment, inhibiting accessibility to the content items comprises hiding the content items. A modified display with the hidden content items may be provided for accessing remaining content items for which gestures have not been received.

In an example embodiment, a selection of a gesture mode may be received for facilitating receipt of gestures for the content items. In an example embodiment, the gesture mode is a display mode enabling a user to configure display of the user interface, such as the user interface 206. On providing the selection of the gesture mode, a display of plurality of content items may be provided to the user. The user may then provide one or more gestures for some of the content items for inhibiting access to some of the content items. In an example embodiment, the received gestures may be treated as passwords by the display for inhibiting access to the content items. Access to the content items may be inhibited by the gestures which may be further utilized for regaining access to the content items. In an example embodiment, a gesture that is utilized for inhibiting access to a particular content item may be utilized for re-accessing the content item. However, in some example embodiments, a particular gesture may be reserved for re-accessing the content items.

In an example embodiment, a user may provide different gestures for different content items. For example, a user may use a cross sign gesture, a question-mark gesture and a dot sign gesture on different content items. A display of the content items may be modified and an access to the content items for which these gestures are received may be inhibited in the display.

In an example embodiment, a receipt of the at least one gesture for the at least one inhibited content item is facilitated. For example, if the user wishes to facilitate access to the inhibited content items, then the user may provide a selection of the gesture mode. On selection of the gesture mode, the user may provide gestures utilized for inhibiting access to the content items. For example, the cross sign gesture may be provided by the user to facilitate access to the content items for which access was inhibited based on the cross sign gesture. Similarly, the user may provide the question-mark gesture and the dot sign gesture to facilitate access to the content items for which access was inhibited based on the respective gestures. In an example embodiment, a user may provide different gesture for each different type of the content items. For example, the user may provide a ‘minus’ (mathematical symbol) gesture for inhibiting access to some of the image files and an “equal to” (mathematical symbol) gesture for inhibiting access to some of the audio/video files. A display may be modified based on the received gestures. The modified display may be provided for viewing remaining content files. An access to the inhibited image files may be facilitated by providing the ‘minus’ gesture and an access to the inhibited audio/video files may be facilitated by providing the ‘equal to’ gesture. In another example embodiment, a single gesture may be provided for inhibiting access to one or more content items.

In an example embodiment, selection of the at least one content item is facilitated. For example, if the user wants to inhibit access to ‘five’ content items, then the user may provide a selection of the five content items by selecting the five content items using any of touch-screen gesture, joystick selection, keypad input and the like and then provide a gesture for inhibiting access to the five content items. In an example embodiment, a ‘selection box’ (such as the selection boxes depicted in FIG. 3E) may be provided adjacent to each content item in the gesture mode for facilitating receipt of the selection of the content item. In an example embodiment, on receiving a selection input for a content item, a ‘tick sign’ may appear for the selected content item. On completion of selection of the content items, a pre-defined gesture (either user-defined gesture or in-built gesture stored in the memory) may be provided to inhibit access to the selected content items. In an example embodiment, a selection box may be provided at a convenient position of the screen for receiving the gesture for the selected content items. In an alternate embodiment, the user may provide the gesture on a substantially middle portion of the screen of the display for inhibiting access to the content items. The inhibited content items may be facilitated access by providing the same gesture utilized for inhibiting access to the content items. In an example embodiment, the user may provide different gestures in the selection boxes associated with content files for inhibiting access and subsequent selective retrieval of the content items.

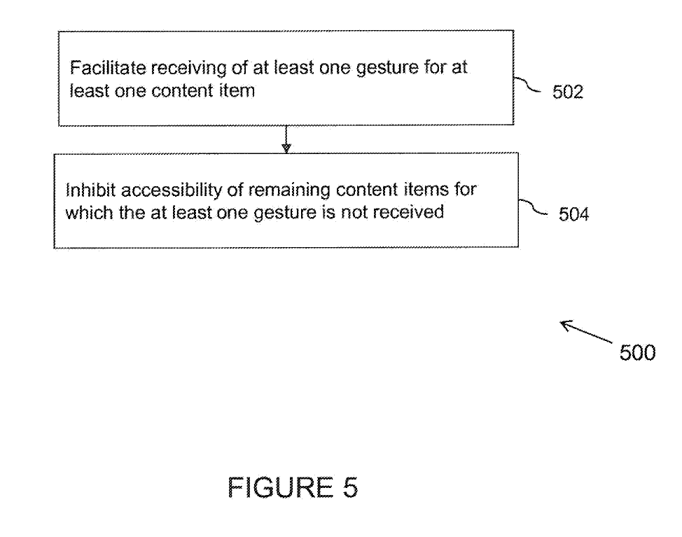

FIG. 5 is a flowchart depicting another example method 500 for managing content in accordance with another example embodiment. The method 500 depicted in flow chart may be executed by, for example, the apparatus 200 of FIG. 2.

At block 502, receiving of at least one gesture for at least one content item is facilitated. At block 504, an access of remaining content items for which gesture is not received is inhibited. In an example embodiment, the gestures may be provided for content files that the user wants the other users to view. Accordingly, an access to the content files may be inhibited for the remaining content items for which the gesture is not received. In an example embodiment, a processing means may be configured to perform some or all of: facilitating receiving of at least one gesture for at least one content item and inhibiting accessibility of remaining content items for which gesture is not received. An example of the processing means may include the processor 202, which may be an example of the controller 108.

For example, if the user wants to share or wants other user to view ‘four’ content items out of ten displayed content items, then gestures may be received from the user for the four content items and an access to the remaining six content items may be inhibited. In an example embodiment, the remaining content items may be replaced by dummy content items (as explained in FIG. 3B). In another example embodiment, the remaining content items may be blurred (as explained in FIG. 3C) for inhibiting access to the content items. In yet another example embodiment, the remaining content items may be hidden (as explained in FIG. 3D) for inhibiting access to the content items. A display may be modified to reflect the inhibited access to the content items. The modified display may be provided for accessing the content items for which access is facilitated.

In an example embodiment, a processing means may be configured to perform some or all of: facilitating receiving of at least one gesture for at least one content item and inhibiting accessibility of the at least one content item based on the gesture. An example of the processing means may include the processor 202, which may be an example of the controller 108.

Without in any way limiting the scope, interpretation, or application of the claims appearing below, a technical effect of one or more of the example embodiments disclosed herein is to enable a user of a content device to share content, such as content items. Managing of content may refer to enabling a user to select some content items out of the content and share the content items with family, friends and colleagues, while reserving the remaining content items for personal usage. Accordingly, gestures for the content items that the user wants to share or wants other users to view may be received and access to the content items may be inhibited based on the gestures. Only those content items that the user wants to share may be accessed by other users. Different forms of modified displays may be generated as exemplified in FIGS. 3B to 3D. This manner of managing content precludes need for cumbersome passwords to protect content items.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-47. (canceled)

48. A method comprising:
facilitating receiving of at least one gesture for at least one content item; and
inhibiting accessibility of the at least one content item based on the at least one gesture.

49. The method as claimed in claim 48, wherein inhibiting accessibility comprises one of:
replacing the at least one content item with at least one dummy content item;
blurring the at least one content item; and
hiding the at least one content item.

50. The method as claimed in claim 48, further comprising:
facilitating receiving of the at least one gesture for the at least one inhibited content item; and
facilitating accessibility of the at least one inhibited content item based on the at least one gesture.

51. The method as claimed in claim 48, further comprising facilitating selection of the at least one content item.

52. A method comprising:
facilitating receiving of at least one gesture for at least one content item; and
inhibiting accessibility of remaining content items for which the at least one gesture is not received.

53. The method as claimed in claim 52, wherein inhibiting accessibility comprises one of:
replacing the remaining content items with at least one dummy content item;
blurring the remaining content items; and
hiding the remaining content items.

54. The method as claimed in claim 52, further comprises:
facilitating receiving of the at least one gesture for the inhibited remaining content items; and
facilitating accessibility of the inhibited remaining content items based on the at least one gesture.

55. The method as claimed in claim 52, further comprising facilitating selection of the at least one content item.

56. An apparatus comprising:
at least one processor; and
at least one memory comprising computer program code, the at least one memory and the computer program code configured to, with the at least one processor, cause the apparatus at least to:
facilitate receiving of at least one gesture for at least one content item; and
inhibit accessibility of the at least one content item based on the at least one gesture.

57. The apparatus as claimed in claim 56, wherein to inhibit accessibility, the apparatus is further caused, at least in part, to perform one of:
replace the at least one content item with at least one dummy content item;
blur the at least one content item; and
hide the at least one content item.

58. The apparatus as claimed in claim 56, wherein the apparatus is further caused, at least in part, to:
facilitate receiving of the at least one gesture for the at least one inhibited content item; and
facilitate accessibility of the at least one inhibited content item based on the at least one gesture.

59. The apparatus as claimed in claim 56, wherein the apparatus is further caused, at least in part, to:
facilitate selection of the at least one content item.

60. The apparatus as claimed in claim 56, wherein the content item comprises at least one of multimedia files, audio files, video files, text files, icons, hyperlinks, bookmarks, and thumbnails.

61. An apparatus comprising:
at least one processor; and
at least one memory comprising computer program code, the at least one memory and the computer program code configured to, with the at least one processor, cause the apparatus at least to:
facilitate receiving of at least one gesture for at least one content item; and
inhibit accessibility of remaining content items for which the at least one gesture is not received.

62. The apparatus as claimed in claim 61, wherein the content item comprises at least one of multimedia files, audio files, video files, text files, icons, hyperlinks, bookmarks, and thumbnails.

63. A computer program product comprising a set of instructions, which, when executed by one or more processors, cause an apparatus at least to:
facilitate receiving of at least one gesture for at least one content item; and
inhibit accessibility of the at least one content item based on the at least one gesture.

64. The computer program as claimed in claim 63, wherein to inhibit accessibility, the apparatus is further caused, at least in part, to perform one of:
replace the at least one content item with at least one dummy content item;
blur the at least one content item; and
hide the at least one content item.

65. The computer program as claimed in claim 63, wherein the apparatus is further caused, at least in part, to:
facilitate receiving of the at least one gesture for the at least one inhibited content item; and
facilitate accessibility of the at least one inhibited content item based on the at least one gesture.

66. The computer program as claimed in claim 63, wherein the apparatus is further caused, at least in part, to:
facilitate selection of the at least one content item.

67. The computer program as claimed in claim 63, wherein the content item comprises at least one of multimedia files, audio files, video files, text files, icons, hyperlinks, bookmarks, and thumbnails.

68. A computer program product comprising a set of instructions, which, when executed by one or more processors, cause an apparatus at least to perform:
facilitate receiving of at least one gesture for at least one content item; and
inhibit accessibility of remaining content items for which the at least one gesture is not received.
